(19) United States
(12) Patent Application Publication
(10) Pub. No.: US 2024/0361128 A1
(43) Pub. Date: Oct. 31, 2024

(54) ADAPTIVE NON-VISUAL NAVIGATIONAL GUIDANCE FOR ELECTRONIC DEVICES

(71) Applicant: Apple Inc., Cupertino, CA (US)

(72) Inventors: Kaushik RAGHUNATH, Pleasanton, CA (US); Pavel V. DUDRENOV, San Francisco, CA (US)

(21) Appl. No.: 18/384,820

(22) Filed: Oct. 27, 2023

Related U.S. Application Data
(60) Provisional application No. 63/462,964, filed on Apr. 28, 2023.

(51) Int. Cl. G01C 21/20

(52) U.S. Cl. CPC G01C 21/206

(57) ABSTRACT

Implementations of the subject technology provide adaptive non-visual navigational guidance for electronic devices. The non-visual navigational guidance may be provided in the form of spatialized audio and/or spatialized haptic output from an electronic device. The non-visual navigational guidance may be based on a three-dimensional map of a portion of a physical environment, and may adapt to physical objects detected in the path of the guidance, in real time, during providing of the non-visual navigational guidance.

### CROSS REFERENCE TO RELATED APPLICATIONS

This application claims the benefit of priority to U.S. Provisional Patent Application No. 63/462,964, entitled, “Adaptive Non-Visual Navigational Guidance For Electronic Devices”, filed on Apr. 28, 2023, the disclosure of which is hereby incorporated herein in its entirety.

### TECHNICAL FIELD

The present description relates generally to electronic devices, including, for example, adaptive non-visual navigational guidance for electronic devices.

### BACKGROUND

Electronic devices are often provided with mapping applications that can provide two-dimensional walking, biking, or driving directions, between outdoor geographical locations on a two-dimensional geographical map, by displaying the two-dimensional geographical map with the electronic device. Turn-by-turn directions can be overlaid on the two-dimensional geographical map, and can be provided in audio output by the electronic device. Typically, this type of navigational guidance is provided by a user's smartphone, based on the two-dimensional map and a Global Positioning System (GPS) signal obtained by the smartphone, while the user holds the smartphone or mounts or otherwise places the smartphone in a vehicle or bicycle. This navigational guidance is typically provided using two-dimensional geographical maps that are obtained from servers that are remote from the location of the electronic device while the navigational guidance is provided.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system.

FIG. 2 illustrates an example of an electronic device providing non-visible navigational guidance within a building in accordance with one or more implementations.

FIG. 3 illustrates an example of an electronic device providing adaptive non-visible navigational guidance within a building in accordance with one or more implementations.

FIG. 4 illustrates an example of an electronic device providing three-dimensional non-visible navigational guidance in accordance with one or more implementations.

FIG. 5 illustrates an example hand-wearable device that can be used to output non-visible navigational guidance in accordance with one or more implementations.

FIG. 6 illustrates the example hand-wearable device of FIG. 5 providing tactile feedback representing a face of remote user in accordance with one or more implementations.

FIG. 7 illustrates a flow chart of an example process for providing adaptive non-visual navigational guidance in accordance with implementations of the subject technology.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Implementations of the subject technology described herein provide non-visual navigational guidance using an electronic device, such as an electronic device having one or more sensors for sensing objects in a physical environment of the electronic device. Non-visual navigational guidance can be useful, as examples, to a person that is a visually occupied (e.g., a walker, a bike rider, or a driver of a car) and/or to a visually impaired person. The non-visual navigational guidance can be based on a three-dimensional map of a physical environment, and can be provided in the form of spatial audio (e.g., beeps or other sounds generated to be perceived as coming from an indicated direction of travel) or spatial haptics (e.g., haptic taps or other haptic outputs generated to be perceived as coming from a location associated with an indicated direction of travel), in some examples. The non-visual navigational guidance can be provided within a building, and can include adaptive navigational guidance around new, moved, moving, and/or changed objects in the physical environment. Some or all of the spatial haptics can be provided by a glove or other hand-wearable device.

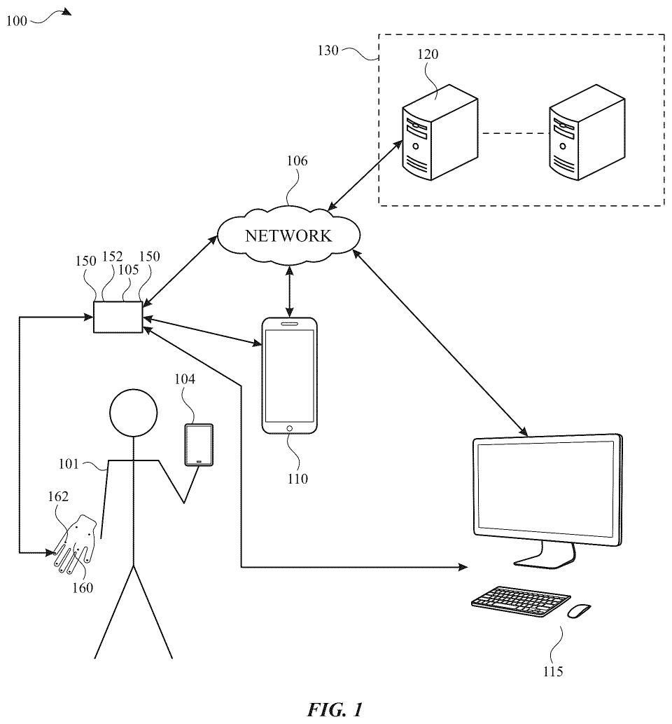

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices and any number of servers or a data center including multiple servers.

The electronic device 105 may be smartphone, a tablet, or a wearable device such as a head mounted portable system (e.g., a head mounted display device or other head mountable device) that can be worn by a user such as user 101, that includes a display system capable of presenting an extended reality environment including one or more visualizations of non-visible features of physical environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In one or more implementations, instead of, or in addition to, utilizing the electronic device 105 to access an extended reality environment, the user may use a handheld electronic device 104, such as a tablet, watch, mobile device, and the like. In one or more implementations, the handheld electronic device 104 may include haptic components that can provide, non-visual navigational guidance, in combination or cooperation with the electronic device 105 and/or the haptic feedback device 160.

The electronic device 105 may include one or more cameras such as cameras 150 (e.g., visible light cameras, infrared cameras, etc.) Further, the electronic device 105 may include various sensors 152 including, but not limited to, cameras, image sensors, touch sensors, microphones, inertial measurement units (IU), heart rate sensors, temperature sensors, Lidar sensors, radar sensors, sonar sensors, GPS sensors, Wi-Fi sensors (e.g., including a wireless communications antenna configured to send and/or receive Wi-Fi signals), gas sensors, airflow sensors, near-field communications sensors and/or antennas, millimeter wave radar sensors, light intensity sensors, air quality sensors, humidity sensors, potential of hydrogen (PH) sensors, moisture sensors, flame sensors, steam detection sensors, etc. Lidar sensors, radar sensors, sonar sensors, time-of-flight sensors and the like may be included and/or combined in sensors 152 to form depth sensors. Depth sensors of sensors 152 can be used to obtain depth information for a physical environment of electronic device 105, which can be used to generate one or more depth maps of some or all of the physical environment. Moreover, the electronic device 105 may include hardware elements that can receive user input such as hardware buttons or switches.

User input detected by such sensors and/or hardware elements correspond to various input modalities for initiating display of visualizations of one or more non-visible phenomena in the physical environment. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. The electronic device 105 may also detect (e.g., using cameras 150 and/or sensors 152) a presence of a person or object and/or one or more non-visible features of a physical environment that would not be visible to a user of the electronic device 105 without the use of the head mounted system.

The electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an implementation, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner.

The network 106 may communicatively (directly or indirectly) couple, for example, the electronic device 105, the electronic device 110 and/or the electronic device 115 with the server 120. In one or more implementations, the network 106 may be an interconnected network of devices that may include, or may be communicatively coupled to, the Internet.

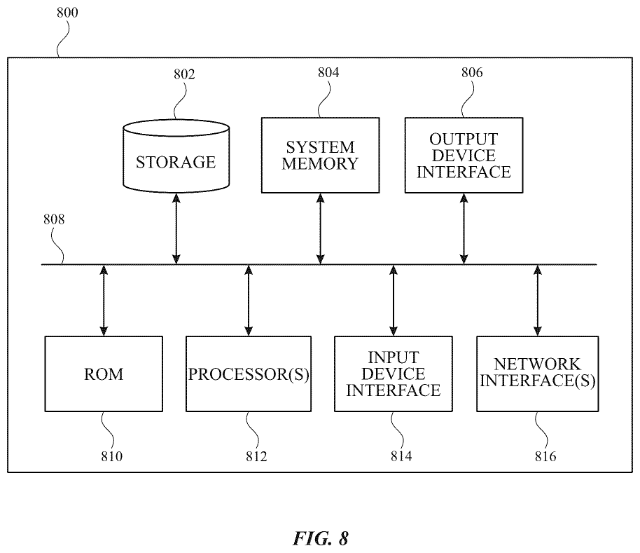

The electronic device 110 may include a touchscreen and may be, for example, a smartphone, a portable computing device such as a laptop computer, a peripheral device (e.g., a digital camera, headphones), a tablet device, a wearable device such as a watch, a band, and the like, any other appropriate device that includes, for example, processing and communications circuitry, or any electronic device with a touchpad. In one or more implementations, the electronic device 110 may not include a touchscreen but may support touchscreen-like gestures, such as in an extended reality environment. In one or more implementations, the electronic device 110 may include a touchpad. In FIG. 1, by way of example, the electronic device 110 is depicted as a mobile smartphone device with a touchscreen. In one or more implementations, the electronic device 110, the handheld electronic device 104, and/or the electronic device 105 may be, and/or may include all or part of, the electronic device discussed below with respect to the electronic system discussed below with respect to FIG. 8. In one or more implementations, the electronic device 110 may be another device such as an Internet Protocol (IP) camera, a tablet, or a peripheral device such as an electronic stylus, etc.

The electronic device 115 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 8.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, maps, building schematics or schematics for other structures, audio and multi-media files, and the like for extended reality environments. In an implementation, the server 120 may function as a cloud storage server that stores any of the aforementioned extended reality content generated by the above-discussed devices and/or the server 120.

As shown in FIG. 1, the system architecture 100 may also include haptic feedback device 160 (e.g., a hand-carriable device or a hand-wearable device configured to be carried by and/or worn on a user's hand). As shown, the haptic feedback device 160 may be capable of communications with the electronic device 105 (e.g., and/or any or all of the handheld electronic device 104, the electronic device 110, the electronic device 115, and/or the servers 130). In one or more implementations, the haptic feedback device 160 may include Bluetooth, Wi-Fi, or other wireless communications circuitry for communicating with the electronic device 105 directly, and/or via the network 106. As shown, the haptic feedback device 160 may include one or more haptic components 162. The haptic components 162 may be operable separately, or in groups, to provide tactile feedback to the user 101 when the haptic feedback device 160 is worn on the user's hand.

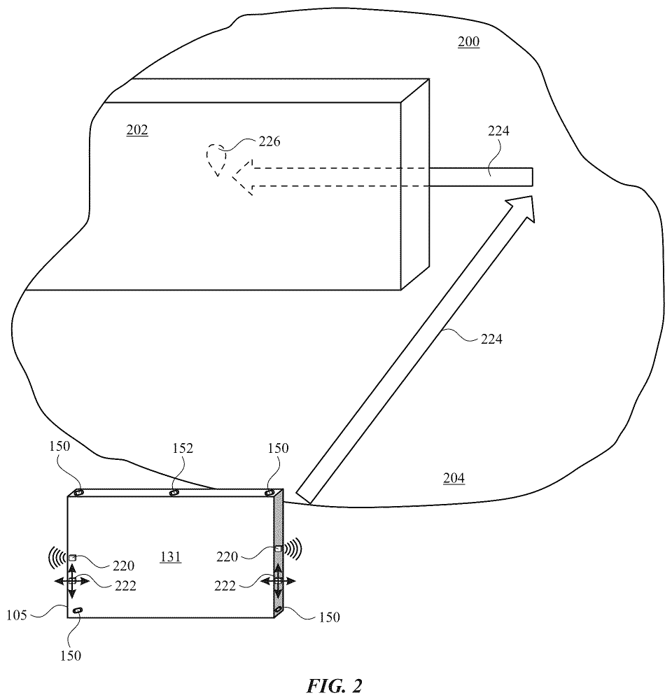

FIG. 2 illustrates an example physical environment in which an electronic device such as the electronic device 105, the haptic feedback device 160, and/or any other of the electronic devices of FIG. 1 can be operated. In the example, of FIG. 2, the electronic device 105 provides, using a non-visual output of the electronic device 105, navigational guidance along a route 224 from a current location of the electronic device 105 toward a remote location 226 in a physical environment 200. For example, the navigational guidance may be provided using a three-dimensional map of the physical environment 200. For example, the three-dimensional map may include one or more three-dimensional meshes, textures, and/or other attributes that describe the locations, shapes, sizes, positions, textures, etc. of the floors (e.g., floor 204), the walls (e.g., physical wall 202), and/or other physical objects in the physical environment 200. For example, the three-dimensional map may have been generated, in whole or in part, by the electronic device 105 using the cameras 150 and/or sensors 152 (e.g., depth sensors) of the electronic device 105. For example, the three-dimensional map of the physical environment 200 may be generated by the electronic device 105 as a user of the electronic device navigates the physical environment 200 (e.g., by walking around their home, office, or other location) while carrying or wearing the electronic device 105.

As shown in FIG. 2, an electronic device, such as the electronic device 105, may include or more components for generating non-visual outputs. In the example of FIG. 2, the electronic device 105 includes two speakers 220 and two haptic components 222. In various implementations, the speakers 220 may be operable to generate spatial audio outputs that interfere with each other such that they are perceived by a user (e.g., user 101) as emanating from one or more locations, remote from the electronic device 105 and/or the speakers 220, in the physical environment 200. In one or more implementations, the speakers 220 may be operable to generate the spatial audio outputs at perceived locations that direct or draw the user of the electronic device 105 toward (or away from) those perceived locations. For example, a beep or beeps that are perceived by the user of the electronic device 105 as emanating from a location to the left of the user of the electronic device 105 may provide non-visual navigational guidance to the user to move or turn to the left, or a beep or beeps that are perceived by the user of the electronic device 105 as emanating from a location in front of the user may be perceived by the user as navigational guidance to continue moving in the same direction in which the user is currently moving.

As another example, rather than spatialized beeps that are perceived by a user as emanating from locations around the user, the speakers 220 may be operable to output spatialized spoken voice audio outputs that guide the user along the route 224 using both spoken guidance and the perceived location of the spoken guidance. For example, the electronic device 105 may operate the speakers 220 to output a human, or human-sounding, voice that states “in three more steps turn right”. The electronic device 105 may operate the speakers 220 output the “in three more steps turn right” directions such that the “in three more steps turn right” directions are perceived by the user of the electronic device 105 as emanating from a location to the right of the user of the electronic device 105. In another example, rather than speaking the direction in which the guidance intends the user to turn, the electronic device 105 may operate the speakers 220 to output spoken words, “come this way”, from a perceived location in the direction in which the guidance intends the user to proceed. Although two speakers 220 and two haptic components 222 are shown in FIG. 2, this is merely illustrative and, in other implementations, the electronic device 105 may be provided with less than two speakers, more than two speakers, less than two haptic components, more than two haptic components, and/or any other components capable of outputting non-visible outputs that are sense-able by a person.

In one or more implementations, the remote location 226 may be location that has been previously pinned by a user of the electronic device 105 (e.g., via a user input to the electronic device 105) in a three-dimensional map of the physical environment 200. For example, the remote location 226 may be a location of a physical object (e.g., a couch, a lamp, a switch, a door, a window, a bed, a nightstand, a dresser, a cabinet, etc.) or a room (e.g., a bathroom, a garage, a kitchen, a closet, etc.) that has been detected, identified, and/or classified using the cameras 150 and/or the sensors 152 of the electronic device 105. In one or more implementations, the user may have previously indicated that the location of the physical object (e.g., and a label for the physical object, such as “my couch”, “the downstairs bathroom”, “my nightstand”, or “the kitchen”) is to be stored (e.g., pinned). In one or more implementations, the electronic device 105 may provide the navigational guidance to the remote location 226 responsive to a user request for guidance to the label for the pinned location (e.g., a voice input or other input to “take me to the kitchen”).

In one or more implementations, the remote location may be a location of another device that transmits location information indicating its own location. For example, the other device may be any device having ultrawide band (UWB) or other wireless capabilities and that can transmit a UWB (or other wireless) signal that can be used to locate the other device. In one or more implementations, the other device may be a labeled device (e.g., having a label stored at the electronic device 105), and the navigational guidance can be provided by the electronic device 105, using the wireless signal from the other device and the three-dimensional map of the physical environment, responsive to a request for guidance to the label for that device (e.g., a voice input to the electronic device 105 to “take me to my phone”, “take me to my smart watch”, or “take me to my tracker device”). The other device may be a device of the user of the electronic device 105 or a device of another user that is voluntarily sharing its location. For example, a friend of the user of the electronic device 105 may instruct a smartphone or other device of the friend to share the location of the smartphone or other device of the friend with the electronic device 105. The smartphone or other device of the friend may be labeled at the electronic device 105 (e.g., in an address book under “Friend Name”). The electronic device 105 may provide, using the shared location of the friend's device and the three-dimensional map of the physical environment, navigational guidance to the location of the friend responsive to a user request (e.g., a voice input or other input to “take me to Friend Name”).

As shown, in one or more use cases, the remote location 226 may not be visible to the user or to the cameras 150 and/or sensors 152 of the electronic device 105 from the current location of the electronic device 105 (e.g., the physical wall 202 and/or one or more other physical objects may be disposed between the current location of the electronic device 105 and the remote location 226). In one or more use cases, the route 224 along which the non-visual navigational guidance that guides the user toward the remote location 226 may navigate the user around one or more physical objects that obstruct a direct path to the remote location. As shown in FIG. 2, the route 224 may navigate the user around a physical wall 202.

For example, the physical wall 202 may be included in the three-dimensional map, and the electronic device 105 may generate the route 224 based on the known location of the physical wall 202 in the map. In one or more other implementations, some or all of the physical wall 202 may be missing from the three-dimensional map, and the electronic device 105 may detect the presence and location of the physical wall 202 (e.g., using cameras 150 and/or sensors 152) while providing the non-visual navigational guidance, and may update and/or modify the route 224 to avoid the physical wall 202. In one or more implementations, the detected physical wall 202 may be added to the three-dimensional map, by the electronic device 105, based on the detection of the physical wall 202 during the providing of the non-visual navigational guidance along the route 224.

Providing the non-visual navigational guidance as in the example of FIG. 2 may be useful for, for example, visually impaired persons to navigate a physical environment. For example, the non-visual navigational guidance can be provided within the user's own home using a map of the user's home generated by the electronic device 105 itself. As another example, the non-visual navigational guidance can be provided within a physical environment that the user is unfamiliar with (e.g., has never or rarely visited) using a map of the unfamiliar physical environment generated by one or more other electronic devices, and provided to the electronic device 105. For example, a person with a visually impaired friend or family member may generate a map of their own home using their own device, and may provide the map to the friend or family member's device (e.g., electronic device 105) when the friend or family member is vising, to allow the friend or family member to non-visually navigate the person's home while vising the home. In these examples, the electronic device 105 that has received the map from a remote source can generate a route to a known location in the map, and provide navigational guidance along the route, based on the remotely received map, while performing object detection, identification, and/or avoidance (e.g., route updates) for physical objects that may not be present in the physical map (e.g., objects that have been moved, changed, or added in the physical environment since the making of the map).

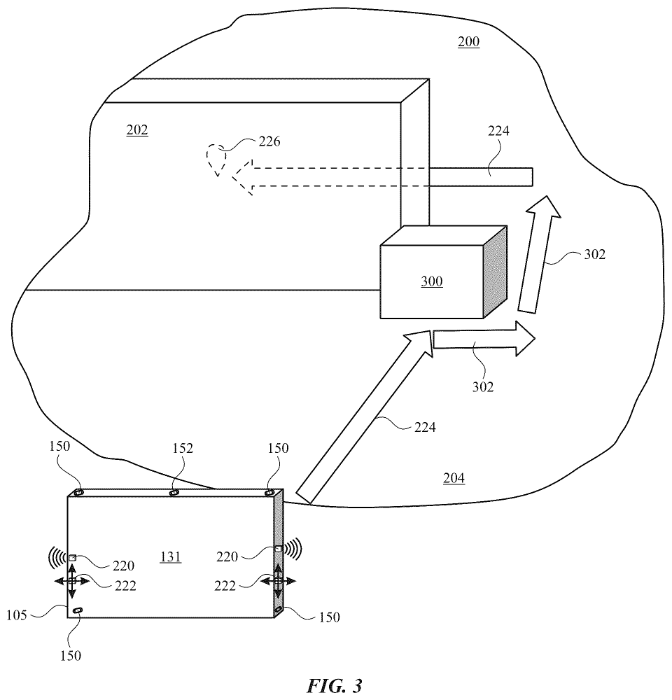

For example, FIG. 3 illustrates a use case in which a physical object 300 that is not included in a three-dimensional map of the physical environment 200 has been added to the physical environment 200. In this example, the newly added physical object 300 obstructs a portion of the route 224 that would otherwise be used by the electronic device 105 for navigation between the current location of the electronic device 105 and the remote location 226. For example, the physical object 300 may be a delivery box, a new table, a new chair, a table or chair that has been moved to a new position, a pair of shoes left on the floor, or any other physical object that can be moved or placed into a location in a physical environment. As another example, the physical object 300 may be a moving object such as a person, a child, an animal, a rolling ball, a vehicle, or other moving object moving into or across the user's path.

As another example, the physical object 300 may be a changed or added portion of a physical object that previously existed in the physical environment 200 and that is included in the three-dimensional map of the physical environment 200. For example, the physical object 300 may represent a door of a cabinet, or a drawer, who has been left open and that obstructs a portion of the route at the current time (e.g., but did not obstruct the route at the time that the three-dimensional map was generated).

In one or more implementations, the speakers 220 and/or the haptic component 222 may be used to provide non-visual (e.g., spatialized audio and/or spatialized haptic) collision warning if the electronic device 105 determines that a collision between the user of the electronic device 105 and the object 300 is possible or imminent. In one or more implementations, the non-visual collision warning may be spatialized audio warning or a spatialized haptic warning that is based on the location, size, shape, and/or other physical characteristic(s) of the object 300. In one or more implementations, spatial audio may be generated to indicate the presence, type, location, and/or shape of the obstructing object (e.g., along with and/or separately from spatial audio corresponding to an updated route for navigating around the obstructing object). For example, a spatial audio collision warning may include spatial audio that indicates the location of one or more edges or boundaries of the object 300 (e.g., based on a mesh corresponding to the object that has been generated and/or otherwise obtained by the electronic device 105) and/or a virtual boundary, generated by the electronic device 105, around the object 300. For example, the electronic device 105 may generate a mesh having a size, shape, and location of a virtual boundary around the object, and can generate spatial audio and/or spatial haptic output based on the mesh.

As indicated in FIG. 3, while the electronic device 105 is providing non-visual navigational guidance along the route 224, the electronic device 105 may detect, using cameras 150 and or sensors 152, the physical object 300 in the path of the user of the electronic device 105. As shown, the electronic device may modify the route 224, such as by adding a route portion 302 to the route 224, to navigate the user around the newly detected physical object 300.

In this way, the subject technology provides various advantages over two-dimensional mapping applications that provide navigational guidance solely based on the current location of a device on a two-dimensional map. For example, in these two-dimensional mapping applications, the mapping is generated using a remote source of information that does not include sensors and or cameras capable of detecting obstructing objects in real time.

In contrast with these two-dimensional mapping applications, the subject technology provides the ability to detect obstructing (e.g., three-dimensional) objects in the user's path, in real time, while providing non-visual navigational guidance, and/or the ability to update the three-dimensional map to include the obstructing objects in real time locally at the user's device. This is different from, for example, a mapping application modifying a driving route based on real-time traffic conditions, at least because mapping applications with traffic avoidance do not detect the traffic using the sensors and/or cameras of the device providing the mapping application, and thus are not able provide navigational guidance around newly detected obstructing objects.

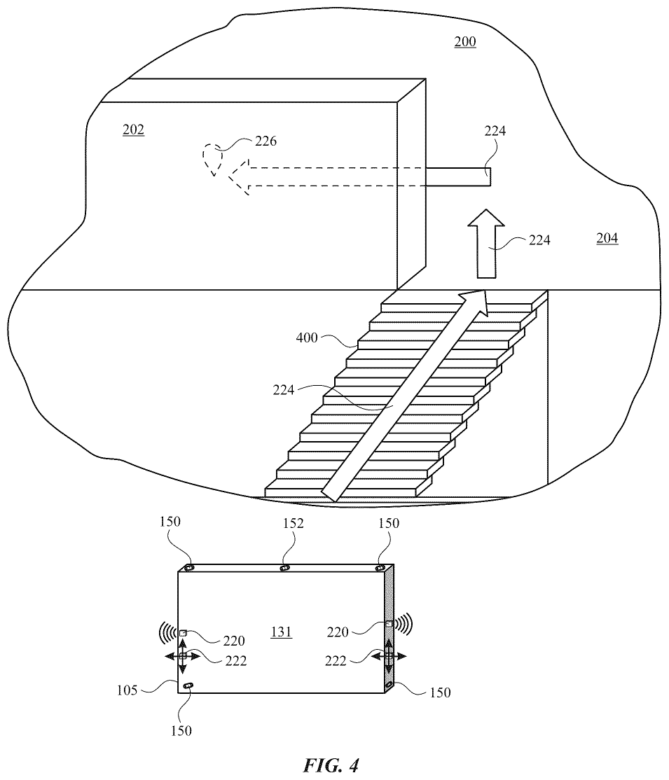

In the example of FIG. 4, the physical object 300 is obstructing the route 224. In one or more use cases, the electronic device 105 may also detect objects (e.g., fixed or moving objects) that are behind the electronic device 105 or behind the user of the electronic device 105. In one or more implementations, the speakers 220 and/or the haptic component 222 may be used to provide a non-visual notification or alert of the detected object behind the user. In one or more use cases, the object behind the user may be a new or moved object in the physical environment 200 that is not included in the three-dimensional map of the physical environment 200, and that is detected using the camera(s) 150 and/or sensor(s) 152 of the electronic device 105. In one or more other use cases, the object behind the user may be detected in the three-dimensional map of the physical environment 200. For example, the object behind the user may be a wall, a table, a chair, or other object that is represented in the three-dimensional map of the physical environment 200, and the electronic device 105 may generate (e.g., using the speakers 220 and/or the haptic components 222) a non-visual notification or alert of the mapped object behind the user, if the user is detected as taking a step backward, or otherwise moving backward, toward the mapped object behind the user.

Because the electronic device 105 may generate and/or use a three-dimensional map of a physical environment, along with object detection and/or tracking, to provide non-visual navigational guidance, the non-visual navigational guidance can also provide vertical navigational guidance in some use cases. For example, FIG. 3 illustrates a use case in which the remote location 226 is located on a different floor of a building from the current location of the electronic device 105. As illustrated in FIG. 3, when navigation is requested (e.g., by a user of the electronic device 105) to the remote location 226 that is on a different floor of the building, the non-visual navigational guidance that is provided (e.g., using spatial outputs by the speakers 220 and/or the haptic components 222) can include navigational guidance along the route 224 that traverses a staircase 400 and navigates around physical objects such as the physical wall 202.

In one or more implementations, the non-visual output may be modified or adjusted to indicate the presence and/or location of the staircase 400. For example, the non-visual output may include spoken-voice output, such as “a first step of a staircase in in your path in three more steps” and/or “there are 12 more steps in this staircase”, which may be output using spatial or non-spatial audio.

The example vertical dimension guidance of FIG. 4 is merely illustrative. In another example use case, the non-visual navigational guidance that is provided by the electronic device 105 can include a smaller range of vertical dimension navigational guidance than guidance up or down a flight of stairs or between floors of a building. For example, a user of the electronic device 105 may request guidance to a handle of a faucet of a sink in the three-dimensional map of the physical environment 200. For example, the user may have previously pinned the location of the handle of the faucet in the three-dimensional map, and/or the electronic device 105 may have previously detected, classified, and stored the location of the handle of the faucet (e.g., with or without user input).

When the user later requests non-visual navigational guidance to the handle of the faucet (e.g., via a voice input or other input to the electronic device 105), the electronic device 105 may first provide non-visual navigational guidance (e.g., using spatial outputs of the speakers 220 and/or the haptic components 222) from the current location of the electronic device to the sink, and may then provide vertical dimension non-visual navigational guidance that guides hand of the user to the handle of the faucet of the sink. For example, the electronic device 105 can output one or more beeps or other audio outputs (e.g., a voice that says “the handle is here”) that are perceived by the user as emanating from the location of the handle. As another example, the electronic device can output one or more beeps or other audio outputs that are perceived by the user as emanating from above the user to guide the user's hands up towards the handle of the faucet, or from below the user to guide the user's hands downward towards the handle of the faucet. In another example use case, the electronic device 105 can provide an even smaller range of non-visual navigational guidance (e.g., using the speakers 220 and/or the haptic components 222 to generate spatial audio outputs and or spatial haptic feedback) to guide the user in inserting a key into a lock, or toward pressing a particular button on a physical keypad (e.g., an automatic teller machine, or a keypad of a car door or building door). In these and other use cases, the electronic device 105 can provide non-visual navigational guidance on large scales (e.g., feet, yards, meters, or miles) and/or small scales (e.g., feet, inches, centimeters, or millimeters) for a user of the electronic device 105.

Although the route 224 is indicated by arrows in FIGS. 2-4 for the purposes of the present discussion, in one or more implementations, a display 131 of the electronic device 105 may not display any visual indication of the route 224 (e.g., the display 131 may be inactive during output of the non-visual navigational guidance).

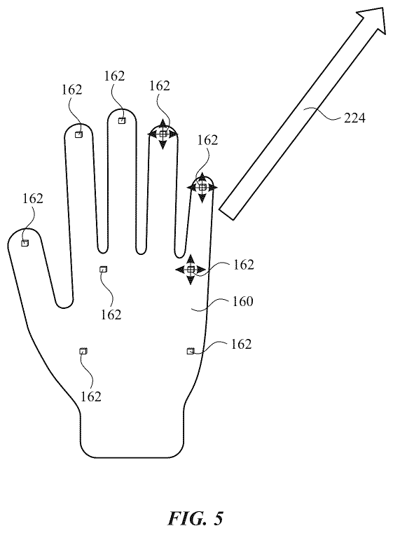

In various examples described herein, non-visual navigational guidance is provided using speakers and/or haptic components of an electronic device, such as the electronic device 105. In one or more implementations, the non-visual navigational guidance can also, or alternatively, be provided using a haptic feedback device (e.g., a hand-carriable or hand-wearable electronic device), such as the haptic feedback device 160. For example, FIG. 5 illustrates and implementation in which the haptic feedback device 160 is implemented as a glove that includes haptic components 222 at various locations in the glove. In the example of FIG. 5, the haptic feedback device 160 includes haptic components 162 in each of the fingers and the thumb of the glove, as well as at various locations on the back or palm of the glove. However, the example of FIG. 5 in which the haptic feedback device 160 is implemented as a glove is merely illustrative, and other implementations of the haptic feedback device 160 are contemplated including, but not limited to, another device that can be worn on the user's hand or a hand-carriable device that can be carried by the user (e.g., a wand, a walking stick, a cane, a white cane, another portable electronic device, or an input device for another electronic device such as the electronic device 105, the electronic device 104, the electronic device 110, and/or the electronic device 115) and that includes haptic components 162 arranged in a manner to be able to provide a spatial haptic output that can indicate a direction and/or an obstruction.

As indicated in FIG. 5, in order to provide non-visual navigational guidance along the route 224, haptic components 162 that are located, relative to the other haptic components in the glove, in the direction of the route 224 may be vibrated or otherwise actuated to indicate to the wearer of the haptic feedback device 160 to move in the direction of the vibrating or actuating haptic components 162. As the wearer moves their hand and/or moves along the route 224 the pattern of haptic components 162 that are vibrated or actuated may change to update the guidance along the route 224. It is also appreciated that this example (in which haptic components 162 on a particular side of a glove are used to indicate a direction) is merely illustrative, and other, more complex uses of haptic components 162 to provide non-visible navigational guidance can also be provided. For example, the haptic components 162 in the haptic feedback device 160 can be operated in patterns that create the sensation of the user's hand being pulled in the direction along the route 224. As another example, the haptic feedback device 160 may operate the haptic components 162 to generate a collision warning (e.g., if an object, such as the object 300 of FIG. 3, is detected in the path of a user). In one or more implementations, a collision warning generated by the haptic components 162 may be a particular vibration that indicates an impending collision, or may be a spatial collision warning that includes feedback that indicates a physical characteristic of the object (e.g., information indicating a location, a size, a shape, and/or other physical characteristic of the object). In one or more implementations, a spatial haptic collision warning may use the haptic component 162 to move in a pattern that generates a sensation of a push or a pull on the wearer's hand to push the wearer away from the object or to guide the user's hand to the location of the object (e.g., to help the user find the object for navigating around the object), or to generate the sensation of touching a virtual boundary (e.g., a virtual boundary defined by a mesh generated by the haptic feedback device 160 or the electronic device 105 based on the size, shape, location, and/or other physical characteristic of the obstructing object) around the object (e.g., to help the wearer avoid contacting the object).

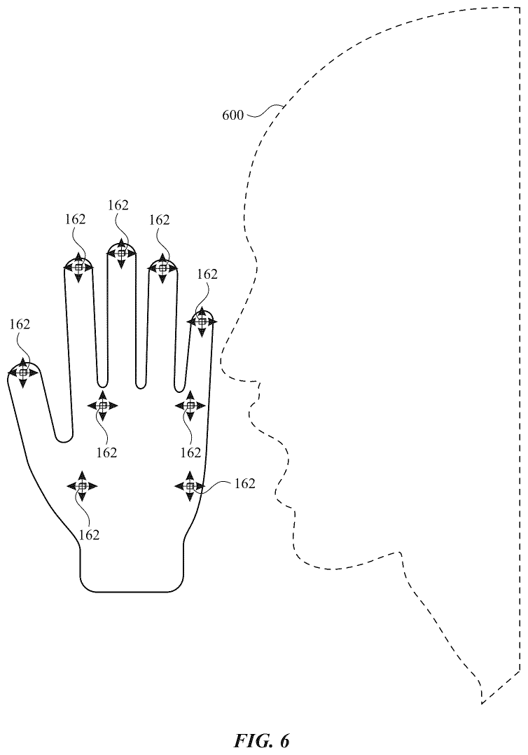

In one or more implementations, haptic feedback device 160 having haptic components 162 as in the example of FIG. 5, can be used for purposes other than navigational guidance. For example, as illustrated in FIG. 6, the haptic components 162 of the haptic feedback device 160 may be vibrated or otherwise actuated based on the locations of the haptic components 162 relative to a three-dimensional mesh of a remote object, such as a remote user's hand or a remote user's face 600 (e.g., so that a grandparent can remotely feel the face or remotely hold the hand of a grandchild). For example, a three-dimensional mesh of the remote user's face or hand may be generated using an electronic device of the remote user, and provided to the electronic device 105 (with the explicit permission of the remote user) and/or the haptic feedback device 160 to be used in operating the haptic components 162 to represent the remote user's face or hand. The example of FIG. 6 in which the haptic components 162 are operated to represent the remote user's face is merely illustrative, and, in other use cases, the haptic components 162 may be operated to represent any remote physical object for which a three-dimensional mesh is available (e.g., for various use cases in which it is desirable for a user to remotely feel the size, shape, or other physical features of a remote object).

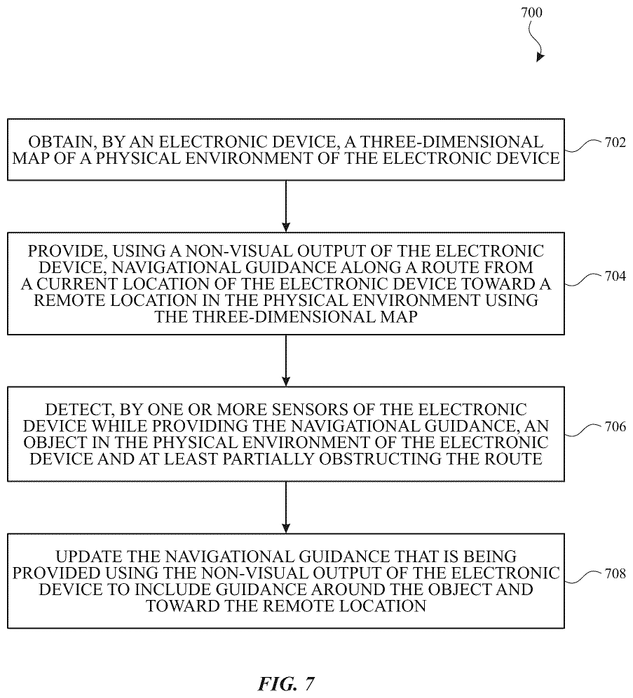

FIG. 7 illustrates a flow diagram of an example process 700 for providing non-visual navigational accordance with implementations of the subject technology. For explanatory purposes, the process 700 is primarily described herein with reference to the electronic device 105 of FIG. 1. However, the process 700 is not limited to the electronic device 105 of FIG. 1, and one or more blocks (or operations) of the process 700 may be performed by one or more other components of other suitable devices, including the electronic device 105, the electronic device 110, the electronic device 115, and/or the servers 120. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, an electronic device (e.g., electronic device 105) may obtain a three-dimensional map of a physical environment (e.g., physical environment 200) of the electronic device. In one or more implementations, obtaining the three-dimensional map may include generating the three-dimensional map using the electronic device. For example, the electronic device may generate some or all of the three-dimensional map locally on-device by sensing the physical environment with one or more cameras (e.g., cameras 150) and/or one or more sensors (e.g., sensors 152) and generating three-dimensional meshes, textures, or other descriptive attributes of the physical environment. In one or more implementations, some or all of the three-dimensional map may be obtained from a remote source (e.g., a remote device or server). For example, the electronic device may be associated with a first user account (e.g., a first user account of a first user of the electronic device 105), and obtaining the three-dimensional map may include obtaining the three-dimensional map from a second electronic device associated with a second user account and associated with a portion of the physical environment (e.g., by receiving a map of a home of a second user associated with the second user account from the second electronic device, when the electronic device enters the home of the second user with permission from the second user). In one or more implementations, the three-dimensional map may include a three-dimensional map of an interior of a building.

At block 704, using a (e.g., non-visual) output of the electronic device, navigational guidance may be provided along a route (e.g., route 224) from a current location of the electronic device toward a remote location (e.g., remote location 226) in the physical environment using the three-dimensional map. For example, the non-visual output may include at least one of a spatial audio output (e.g., from speaker 220) or a spatial haptic output (e.g., from haptic component 222). In one or more implementations, the spatial audio output may include a non-verbal spatial audio output (e.g., a beep or other non-verbal audio content). For example, the non-verbal spatial output may be output by one or more speakers of the electronic device in a spatialized manner that causes the audio output to be perceived as emanating from a location, remote from the electronic device and the speakers in the physical environment, along the route. In one or more other implementations, the spatial audio output may include a spatialized verbal output in the form of a human or human-sounding voice that is output to be perceived as emanating from a direction along the route.

In one or more implementations, the remote location may include a pinned location previously pinned by a user of the electronic device in the three-dimensional map. In one or more implementations, the remote location may include a fixed location in the physical environment. In one or more implementations, the remote location may include a location of a moving object. For example, in one or more implementations, the remote location may include a location of a moving object (e.g., a non-human moving object) in the physical environment that has been previously pinned by a user and tracked, since the pinning, by the electronic device. As illustrative examples, the user may provide a user input to the electronic device requesting that the electronic device track (e.g., using the cameras 150 and/or the sensors 152) the location of the user's keys, phone, or pet. The user may later request non-visual navigational guidance to the current (e.g., tracked) location of the pinned and tracked object.

In one or more implementations, the remote location may be a location of another device of a user of the electronic device or another device of another user. For example, the other device may transmit information (e.g., UWB or other wireless signals) indicating its own location that can be detected by the electronic device. In one or more implementations, the other device may be a labeled device (e.g., having a label stored at the electronic device), and the user of the electronic device may request non-visual navigational guidance to the other device by requesting non-visual navigational guidance to the label, as described herein.

At block 706, an object (e.g., physical wall 202 or physical object 300) in the physical environment of the electronic device and at least partially obstructing the route may be detected using one or more sensors (e.g., cameras 150 and/or sensors 152) of the electronic device while providing the navigational guidance. For example, the object may not be included in the three-dimensional map. In one or more implementations, the object may be a wall in a building. In one or more implementations, the object may be a movable or moving object that is not included in the three-dimensional map (e.g., as described herein in connection with FIG. 3). In one or more implementations, the object may include a modified portion of an object that is included in the three-dimensional map (e.g., a door of cabinet, or a drawer of a dresser that has been left open since the three-dimensional map was generated).

At block 708, the electronic device may update the navigational guidance that is being provided using the non-visual output of the electronic device to include guidance around the object and toward the remote location. For example, the electronic device may add a route portion (e.g., route portion 302 of FIG. 3) to the route that guides the user of the electronic device around the object. In one or more implementations, the non-visual output of the electronic device may include a collision warning responsive to detection of the object. For example, the collision warning may be provided in spatialized audio output that includes an alarm or other warning sound that is perceived by the user as emanating from the direction or location of the impending collision.

In one or more implementations, the process 700 may also include detecting, by the one or more sensors of the electronic device, one or more additional objects at a location behind a user of the electronic device in the physical environment of the electronic device; and providing, using the non-visual output of the electronic device, a notification of the one or more additional objects behind the user. The notification may include a verbal notification or a non-verbal notification in a spatialized audio output that is perceived by the user of the electronic device to be emanating from the location of the additional object(s) behind the user. The notification may also, or alternatively, include a haptic or other tactile output that is perceived by the user at a location behind the user.

In one or more implementations, the electronic device may be communicatively coupled to a hand-mountable device (e.g., a hand-carriable device or a hand-wearable device, such as the haptic feedback device 160) having a plurality of haptic components (e.g., haptic components 162), and at least a portion of the navigational guidance may be provided by the plurality of haptic components of the hand-mountable device (e.g., as described herein in connection with FIG. 5). In one or more implementations, the process 700 may also include obtaining a mesh of a face a remote user that is absent from the physical environment of the user; and providing a haptic output, corresponding to the mesh of the face of the remote user, from the plurality of haptic components of the hand-mountable device (e.g., as described herein in connection with FIG. 6).

As described above, one aspect of the present technology is the gathering and use of data available from specific and legitimate sources for providing non-visual navigational guidance. The present disclosure contemplates that in some instances, this gathered data may include personal information data that uniquely identifies or can be used to identify a specific person. Such personal information data can include video data, three-dimensional geometry data, object detection data, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used providing non-visual navigational guidance.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing non-visual navigational guidance, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 8 illustrates an electronic system 800 with which one or more implementations of the subject technology may be implemented. The electronic system 800 can be, and/or can be a part of, the electronic device 105, the handheld electronic device 104, the electronic device 110, the electronic device 115, and/or the server 120 as shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810 (which are each implemented as a non-transitory computer-readable medium). From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In accordance with aspects of the disclosure, a method is provided that includes identifying, using sensor data from a sensor of a device, a non-visible feature of a physical environment of the device; obtaining a depth map of at least a portion of the physical environment; identifying, by the device, a visual context for the non-visible feature; and displaying, by the device, a visualization of the non-visible feature of the physical environment using the visual context, the depth map, and the sensor data, the visualization being overlaid on a location in the physical environment corresponding to the non-visible feature of the physical environment.

In accordance with aspects of the disclosure, a device is provided that includes a sensor; one or more processors; and memory storing instructions that, when executed by the one or more processors causes the one or more processors to: identify, using sensor data from the sensor, a non-visible feature of a physical environment of the device; obtain a depth map of at least a portion of the physical environment; identify a visual context for the non-visible feature; and display a visualization of the non-visible feature of the physical environment using the visual context, the depth map, and the sensor data, the visualization being overlaid on a location in the physical environment corresponding to the non-visible feature of the physical environment.

In accordance with aspects of the disclosure, a non-transitory computer-readable medium is provided, the non-transitory computer-readable medium storing instructions that, when executed by one or more processors of a device, cause the one or more processors to: identify, using sensor data from a sensor of the device, a non-visible feature of a physical environment of the device; obtain a depth map of at least a portion of the physical environment; identify a visual context for the non-visible feature; and display a visualization of the non-visible feature of the physical environment using the visual context, the depth map, and the sensor data, the visualization being overlaid on a location in the physical environment corresponding to the non-visible feature of the physical environment.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A method, comprising:
obtaining, by an electronic device, a three-dimensional map of a physical environment of the electronic device;
providing, using a non-visual output of the electronic device, navigational guidance along a route from a current location of the electronic device toward a remote location in the physical environment using the three-dimensional map;
detecting, by one or more sensors of the electronic device while providing the navigational guidance, an object in the physical environment of the electronic device and at least partially obstructing the route; and
updating the navigational guidance that is being provided using the non-visual output of the electronic device to include guidance around the object and toward the remote location.

2. The method of claim 1, wherein the non-visual output comprises at least one of a spatial audio output or a spatial haptic output.

3. The method of claim 2, wherein the spatial audio output comprises a non-verbal spatial audio output.

4. The method of claim 1, wherein the object comprises a wall in a building.

5. The method of claim 1, wherein the three-dimensional map comprises a three-dimensional map of an interior of a building.

6. The method of claim 1, wherein obtaining the three-dimensional map comprises generating the three-dimensional map using the electronic device.

7. The method of claim 6, wherein the electronic device is associated with a first user account, and wherein obtaining the three-dimensional map comprises obtaining the three-dimensional map from a second electronic device associated with a second user account and associated with a portion of the physical environment.

8. The method of claim 1, wherein the object comprises a moving object that is not included in the three-dimensional map.

9. The method of claim 1, wherein the object comprises a modified portion of an object that is included in the three-dimensional map.

10. The method of claim 1, wherein the remote location comprises a pinned location previously pinned by a user of the electronic device in the three-dimensional map.

11. The method of claim 1, wherein the remote location comprises a location of a moving object in the physical environment that has been previously pinned by a user and tracked, since the pinning, by the electronic device.

12. The method of claim 1, further comprising providing, using the non-visual output of the electronic device, a collision warning responsive to detection of the object, wherein the collision warning comprises a spatial collision warning includes feedback that indicates a physical characteristic of the object.

13. The method of claim 1, further comprising:
detecting, by the one or more sensors of the electronic device, one or more additional objects at a location behind a user of the electronic device in the physical environment of the electronic device; and
providing, using the non-visual output of the electronic device, a notification of the one or more additional objects behind the user.

14. The method of claim 1, wherein the electronic device is communicatively coupled to a hand-mountable device having a plurality of haptic components, and wherein at least a portion of the navigational guidance is provided by the plurality of haptic components of the hand-mountable device.

15. The method of claim 14, further comprising:
obtaining a mesh of a face a remote user that is absent from the physical environment; and
providing a haptic output, corresponding to the mesh of the face of the remote user, from the plurality of haptic components of the hand-mountable device.

16. An electronic device, comprising:
one or more sensors;
a memory; and
one or more processors configured to:
obtain a three-dimensional map of a physical environment of the electronic device,
provide, using at least one of a spatial audio output or a spatial haptic output of the electronic device, navigational guidance along a route from a current location of the electronic device toward a remote location in the physical environment using the three-dimensional map;
detect, using the one or more sensors and while providing the navigational guidance, an object in the physical environment of the electronic device and at least partially obstructing the route; and
update the navigational guidance to include guidance around the object and toward the remote location.

17. The electronic device of claim 16, wherein the remote location comprises a pinned location previously pinned by a user of the electronic device in the three-dimensional map.

18. The electronic device of claim 16, wherein the electronic device comprises a head-mountable electronic device.

19. A non-transitory computer-readable medium storing instructions which, when executed by one or more processors, cause the one or more processors to:
obtain a three-dimensional map of a physical environment of an electronic device,
provide, using at least one of a spatial audio output or a spatial haptic output of the electronic device, navigational guidance along a route from a current location of the electronic device toward a remote location in the physical environment using the three-dimensional map;
detect, using one or more sensors of the electronic device and while providing the navigational guidance, an object in the physical environment of the electronic device and at least partially obstructing the route; and
update the navigational guidance to include guidance around the object and toward the remote location.

20. The non-transitory computer-readable medium of claim 19, wherein the remote location comprises a pinned location of an object previously detected by the electronic device, the pinned location previously pinned by a user of the electronic device in the three-dimensional map.
